(19) United States
(12) Patent Application Publication
(10) Pub. No.: US 2015/0013458 A1
(43) Pub. Date: Jan. 15, 2015

(54) PHYSICAL QUANTITY SENSOR, ELECTRONIC APPARATUS, AND MOVING OBJECT

(71) Applicant: Seiko Epson Corporation, Tokyo (JP)

(72) Inventor: Satoru TANAKA, Chino (JP)

(21) Appl. No.: 14/325,717

(22) Filed: Jul. 8, 2014

(30) Foreign Application Priority Data
Jul. 11, 2013 (JP) 2013-145221

(51) Int. Cl. G01P 15/135; G01P 15/08

(52) U.S. Cl. CPC G01P 15/135; G01P 15/0802
USPC 73/514.35

(57) ABSTRACT

A fixed electrode part, a movable member supported by a support part above the fixed electrode part to which a principal surface thereof is opposed, and a stopper part provided to be opposed to at least a part of an outer edge of the movable member and regulating in-plane rotation displacement of the principal surface of the movable member are provided.

### CROSS-REFERENCE TO RELATED APPLICATIONS

This application claims priority to Japanese Patent Application No. 2013-145221 filed on Jul. 11, 2013. The entire disclosure of Japanese Patent Application No. 2013-145221 is hereby incorporated herein by reference.

### BACKGROUND

1. Technical Field

The present invention relates to a physical quantity sensor, an electronic apparatus, and a moving object.

2. Related Art

In related art, a physical quantity sensor that detects a physical quantity of acceleration or the like including a movable electrode part as a movable member swingably supported by a support part, and a detection electrode part as a fixed electrode part provided to have a gap in a position opposed to the movable member has been known. In the physical quantity sensor, the movable member swings in response to the physical quantity of acceleration or the like applied to the physical quantity sensor, and thereby, the gap between the movable member and the detection electrode part changes. Detection of the physical quantity of acceleration or the like applied to the physical quantity sensor is performed based on a change in capacitance caused between the electrode parts in response to the change in the gap. For example, Patent Document 1 (JP-T-2008-529001) discloses a capacitance physical quantity sensor including a movable electrode part and a detection electrode part provided apart to have a gap with respect to the movable electrode. The physical quantity sensor has a structure in which a projecting portion projecting from one surface of the movable electrode part opposed to the detection electrode part toward the detection electrode part is provided to regulate displacement of the movable electrode part in a direction of the projection.

However, in the above described physical quantity sensor, when acceleration is applied in a second direction crossing a first direction in which the projecting portion projects, it is impossible to regulate the displacement of the movable member with respect to the second direction, and the movable member or the like may be broken.

### SUMMARY

An advantage of some aspects of the invention is to solve at least a part of the problems described above, and the invention can be implemented as the following forms or application examples.

### APPLICATION EXAMPLE 1

A physical quantity sensor according to this application example includes a fixed electrode part, a movable member supported by a support part above the fixed electrode part to which a principal surface thereof is opposed, and a stopper part provided to be opposed to at least a part of an outer edge of the movable member and regulating in-plane rotation displacement of the principal surface of the movable member.

According to the physical quantity sensor, the fixed electrode part and the movable member supported by the support part above the fixed electrode part to which the principal surface thereof is opposed are provided, and measurement of a physical quantity of acceleration or the like may be performed by a change in capacitance caused by a change of a gap between the fixed electrode part and the movable member in response to the physical quantity of acceleration or the like. In the physical quantity sensor, the stopper part that regulates the in-plane rotation displacement of the principal surface of the movable member is provided to be opposed to at least a part of the outer edge of the movable member.

Thereby, the in-plane rotation displacement of the movable member may be regulated. Therefore, breakage of the movable member and breakage of the support part for supporting the movable member due to excessive displacement of the movable member may be reduced. Further, fluctuations in opposed area of the movable member and the fixed electrode part with the in-plane rotation displacement of the principal surface of the movable member decrease and variations in characteristics of the capacitance that changes in response to the acceleration or the like may be reduced.

Thus, the physical quantity sensor in which the breakage of the support part or the like due to excessive displacement of the movable member is suppressed and variations in characteristics of the capacitance between the movable member and the fixed electrode part that changes in response to the acceleration or the like are reduced may be obtained.

### APPLICATION EXAMPLE 2

In the physical quantity sensor according to the application example described above, it is preferable that the stopper part is provided to be opposed to a corner portion of the movable member.

According to the physical quantity sensor with this configuration, the stopper part is provided to be opposed to the corner portion at which the outer edge of the movable member intersects.

Thereby, the displacement in the in-plane rotation direction of the principal surface of the movable member around the rotation axis along a first direction in which the gap between the movable member and the fixed electrode part changes may be regulated. Further, the opposed area of the movable member and the fixed electrode part with the in-plane rotation displacement of the principal surface of the movable member decreases and variations in characteristics of the capacitance that changes in response to the acceleration or the like may be reduced. Thus, the physical quantity sensor in which the breakage of the support part or the like caused by excessive displacement of the movable member is reduced and variations in characteristics of the capacitance between the movable member and the fixed electrode part that changes in response to the acceleration or the like are reduced may be obtained.

### APPLICATION EXAMPLE 3

In the physical quantity sensor according to the application example described above, it is preferable that the stopper part is provided to be opposed to each of a first side and a second side forming an angle with the first side, the sides forming the corner portion of the movable member.

According to the physical quantity sensor with this configuration, the stopper part is provided to be opposed to each of the first side forming the corner portion of the movable member and the second side forming the angle with the first side.

Thereby, the displacement in the in-plane rotation direction of the principal surface of the movable member around the rotation axis along the first direction in which the gap between the movable member and the fixed electrode part changes may be further regulated. Further, the opposed area of the movable member and the fixed electrode part decreases and variations in characteristics of the capacitance that changes in response to the acceleration or the like may be reduced. Thus, the physical quantity sensor in which the breakage of the support part or the like caused by excessive displacement of the movable member is reduced and variations in characteristics of the capacitance between the movable member and the fixed electrode part that changes in response to the acceleration or the like is further reduced may be obtained.

### APPLICATION EXAMPLE 4

In the physical quantity sensor according to the application example described above, it is preferable that the stopper part is provided along the corner portion of the movable member.

According to the physical quantity sensor with this configuration, the stopper and the projection are provided both inside and outside of the movable member, and thereby, the regulation force may be improved with respect to the displacement in the in-plane rotation direction generated in the movable member.

### APPLICATION EXAMPLE 5

In the physical quantity sensor according to the application example described above, it is preferable that a hollow part is provided in the movable member, a fixing part is provided in the hollow part in a plan view of the movable member, and the movable member is suspended by the support part extended from the fixing part.

According to the physical quantity sensor with this configuration, the fixing part is provided in the hollow part provided in the movable member and the movable member is suspended by the support part extended from the fixing part.

Thereby, the physical quantity sensor in which the breakage of the support part or the like caused by excessive displacement of the movable member is suppressed and variations in characteristics of the capacitance between the movable member and the fixed electrode part that changes in response to the acceleration or the like are suppressed may be obtained. Further, the fixing part is placed at one point, and thereby, the influence on the movable member by the stress at fixation may be reduced.

### APPLICATION EXAMPLE 6

In the physical quantity sensor according to the application example described above, it is preferable that a projection is provided on at least one of an edge of the hollow part of the movable member and the fixing part.

According to the physical quantity sensor with this configuration, the fixing part is provided in the hollow part provided in the movable member and the movable member is suspended by the support part extended from the fixing part. Further, the projection is provided on at least one of the edge of the hollow part as the inner edge of the movable member and the fixing part provided in the hollow part.

Thereby, the inner edge of the movable member in which the hollow part is provided is in contact with the fixing part provided in the hollow part, and displacement in the in-plane rotation direction of the principal surface of the movable member around the rotation axis along the first direction may be regulated. Further, the projection is provided on the edge of the hollow part or the fixing part, and thereby, the contact between the fixing part and the movable member may be point contact and the impact of the contact may be relaxed. Furthermore, clinging between the fixing part and the movable part may be reduced because of the point contact.

Therefore, breakage of the movable member and breakage of the support part supporting the movable member due to excessive displacement of the movable member may be further reduced. Further, the displacement in the in-plane rotation direction of the principal surface of the movable member is regulated, and thereby, the opposed area of the movable member and the fixed electrode part decreases and variations in characteristics of the capacitance that changes in response to the acceleration or the like may be reduced.

Thus, the physical quantity sensor in which the breakage of the support part or the like caused by excessive displacement of the movable member is reduced and variations in characteristics of the capacitance between the movable member and the fixed electrode part that changes in response to the acceleration or the like is reduced may be obtained.

### APPLICATION EXAMPLE 7

A physical quantity sensor according to this application example includes a fixed electrode part, a movable member supported above the fixed electrode part to which a principal surface thereof is opposed and including a hollow part, a fixing part provided in the hollow part in a plan view of the movable member, a support part extended from the fixing part toward the movable member and suspending the movable member on the fixing part, and a stopper part provided to be opposed to at least apart of an outer edge of the movable member and regulating in-plane rotation displacement of the principal surface of the movable member.

According to the physical quantity sensor, the fixed electrode part and the movable member opposed to the fixed electrode part and including the hollow part are provided. Further, the fixing part is provided to be inside of the hollow part and the movable member is suspended by the support part extended from the fixing part. Furthermore, the stopper is provided along at least a part of the outer edge of the movable member.

Thereby, the inner edge of the movable member in which the hollow part is provided is in contact with the fixing part provided in the hollow part, and displacement in the in-plane rotation direction of the principal surface of the movable member around the rotation axis along the first direction may be regulated. Therefore, breakage of the movable member and breakage of the support part supporting the movable member due to excessive displacement of the movable member may be reduced. Further, the displacement in the in-plane rotation direction of the principal surface of the movable member is regulated, and thereby, the opposed area of the movable member and the fixed electrode part decreases and variations in characteristics of the capacitance that changes in response to the acceleration or the like may be reduced.

Thus, the physical quantity sensor in which the breakage of the support part or the like caused by excessive displacement of the movable member is suppressed and variations in characteristics of the capacitance between the movable member and the fixed electrode part that changes in response to the acceleration or the like are reduced may be obtained. The fixing part is placed at one point, and the influence on the movable member by the stress at fixation may be reduced.

### APPLICATION EXAMPLE 8

In the physical quantity sensor according to the application example described above, it is preferable that the stopper part has a projection shape.

According to the physical quantity sensor with this configuration, the stopper part has the projection shape, and the contact with the movable member may be point contact. Thus, the impact of the contact between the movable member and the stopper part may be relaxed.

### APPLICATION EXAMPLE 9

In the physical quantity sensor according to the application example described above, it is preferable that the stopper part and the movable member are at the same potential.

According to the physical quantity sensor with this configuration, the stopper part and the movable member are at the same potential, and, when they are in contact, variations and losses in capacitance caused between the movable member and the fixed electrode part may be reduced. Therefore, the physical quantity sensor that can continuously measure the physical quantity of acceleration or the like when the movable member and the stopper part are in contact may be obtained.

### APPLICATION EXAMPLE 10

An electronic apparatus according this application example includes any one of the above described physical quantity sensors.

According to the electronic apparatus, the physical quantity sensor in which displacement of the movable member in a second direction crossing the first direction in which the gap between the movable member and the fixed electrode part changes and the in-plane rotation displacement of the principal surface of the movable member around the rotation axis along the first direction are regulated and, even when excessive acceleration or the like is applied, the acceleration or the like may be continuously detected is mounted. Thus, reliability of the electronic apparatus with the above described physical quantity sensor may be improved.

### APPLICATION EXAMPLE 11

A moving object according the application example includes any one of the above described physical quantity sensors.

According to the moving object, the physical quantity sensor in which displacement of the movable member in the second direction crossing the first direction in which the gap between the movable member and the fixed electrode part changes and the in-plane rotation displacement of the principal surface of the movable member around the rotation axis along the first direction are regulated and, even when excessive acceleration or the like is applied, the acceleration or the like may be continuously detected is mounted. Thus, reliability of the moving object with the above described physical quantity sensor may be improved.

### BRIEF DESCRIPTION OF THE DRAWINGS

The invention will be described with reference to the accompanying drawings, wherein like numbers reference like elements.

FIG. 1 is a plan view schematically showing a physical quantity sensor according to a first embodiment.

FIG. 2 is a sectional view schematically showing the physical quantity sensor according to the first embodiment.

FIG. 3 is a sectional view schematically showing the physical quantity sensor according to the first embodiment.

FIGS. 4A to 4C are schematic diagrams for explanation of an action of the physical quantity sensor according to the first embodiment.

FIG. 5 is a plan view schematically showing a physical quantity sensor according to a second embodiment.

FIG. 6 is a sectional view schematically showing the physical quantity sensor according to the second embodiment.

FIG. 7 is a plan view schematically showing a physical quantity sensor according to a modified example 1.

FIG. 8 is a plan view schematically showing a physical quantity sensor according to a modified example 2.

FIG. 9 is an enlarged view schematically showing a part of a physical quantity sensor according to a modified example 3.

FIG. 10 schematically shows a personal computer as an electronic apparatus according to a working example.

FIG. 11 schematically shows a cell phone as an electronic apparatus according to a working example.

FIG. 12 schematically shows a digital still camera as an electronic apparatus according to a working example.

FIG. 13 schematically shows an automobile as a moving object according to a working example.

### DESCRIPTION OF EXEMPLARY EMBODIMENTS

As below, embodiments of the invention will be explained using the drawings. Note that, in the following respective drawings, the dimensions and ratios of the respective component elements may be appropriately differentiated from the actual component elements so that the respective component elements may have sizes to the degrees that can be recognized on the drawings.

### First Embodiment

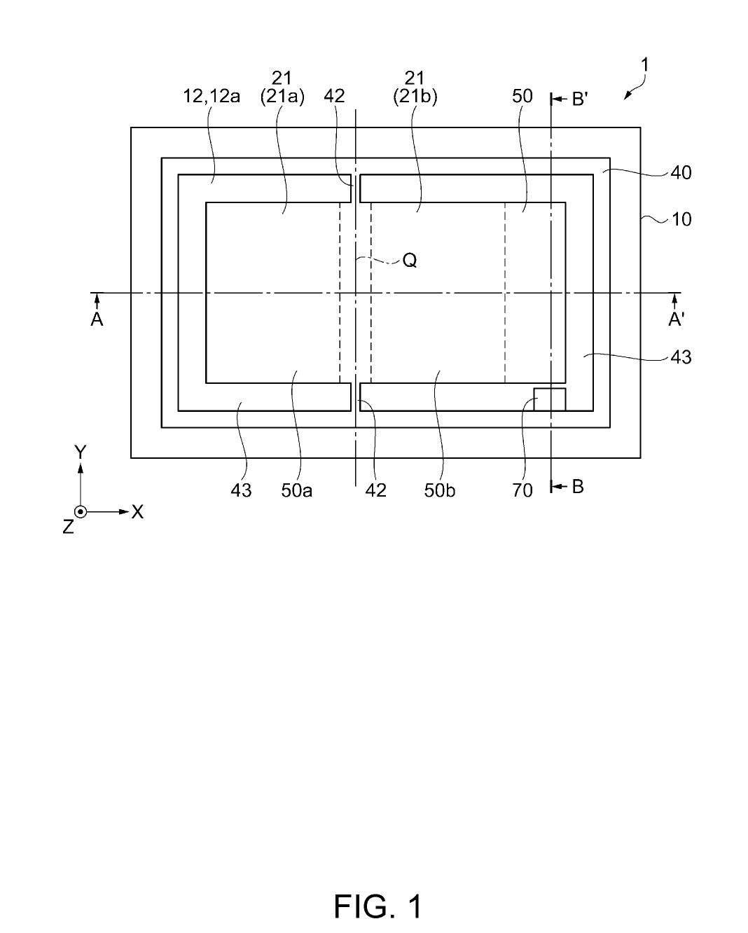

A physical quantity sensor according to the first embodiment will be explained using FIGS. 1 to 4C.

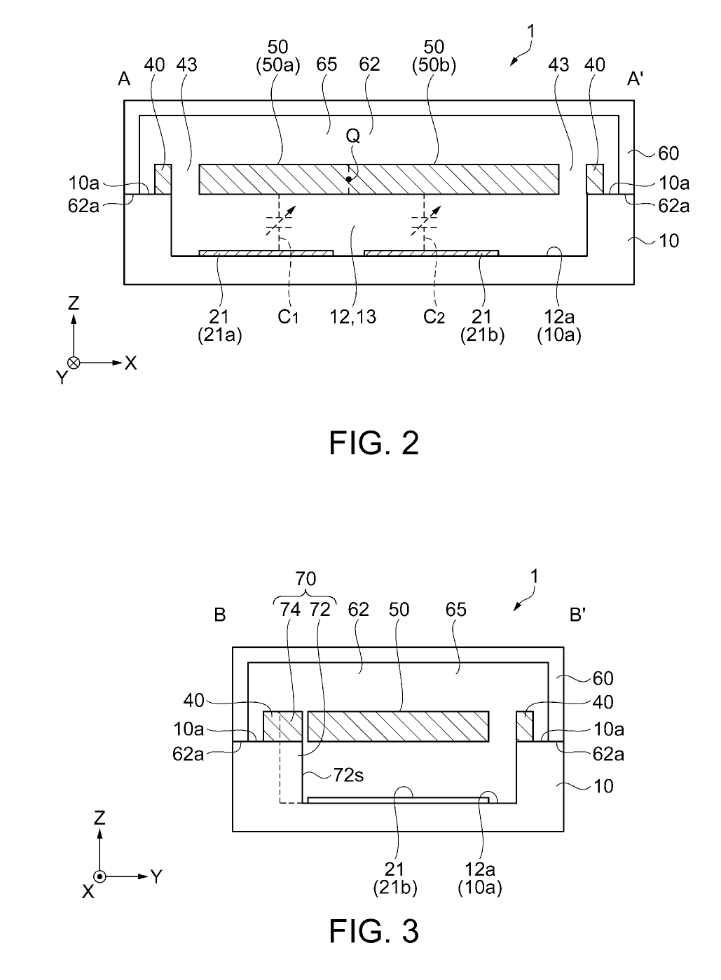

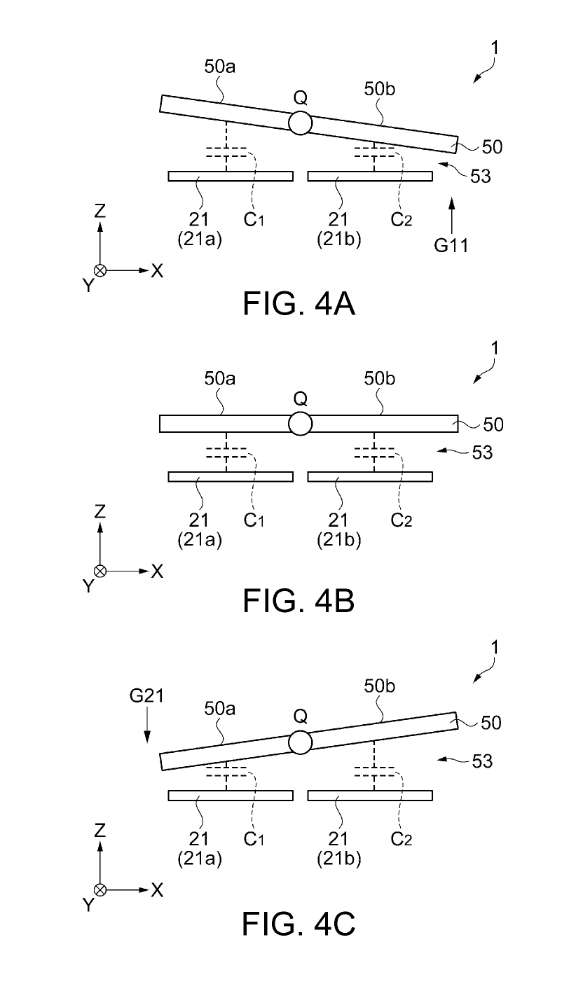

FIG. 1 is a plan view showing an outline of the physical quantity sensor according to the first embodiment. FIG. 2 is a sectional view schematically showing a section of the physical quantity sensor in a part shown by line segment A-A′ in FIG. 1. FIG. 3 is a sectional view schematically showing a section of the physical quantity sensor in a part shown by line segment B-B′ in FIG. 1. FIGS. 4A to 4C are schematic diagrams for explanation of an action of the physical quantity sensor according to the first embodiment.

For convenience of explanation, illustration of wiring parts connected to the respective electrode parts etc. are omitted in FIGS. 1 to 4C. Further, the illustration of a lid member is omitted in FIG. 1. Furthermore, in FIGS. 4A to 4C, the illustration of other parts than a movable member and a detection electrode part is omitted. Note that, in FIGS. 1 to 4C, an X-axis, a Y-axis, and a Z-axis are shown as three axes orthogonal to one another. The Z-axis is an axis indicating a thickness direction in which a substrate and the lid member overlap.

### Structure of Physical Quantity Sensor 1

The physical quantity sensor 1 of the embodiment may be used as an inertia sensor, for example. Specifically, the physical quantity sensor may be used as a sensor for measurement of a physical quantity of acceleration in the vertical direction (Z-axis direction) (a capacitance acceleration sensor, a capacitance MEMS acceleration sensor).

In the physical quantity sensor 1, as shown in FIGS. 1 to 3, a substrate 10, detection electrode parts 21 as a fixed electrode part on the substrate 10, and a movable member 50 having gaps with respect to the detection electrode parts 21 and supported by a frame part 40 via support parts 42. Further, in a plan view from the Z-axis direction as a perpendicular direction with respect to the substrate 10, a stopper part 70 is provided along an edge of an outer shape (hereinafter, referred to as “outer edge”) of the movable member 50 between the frame part 40 and the edge on the substrate 10, and a lid member 60 that covers the movable member 50 etc. is provided.

### Substrate 10

The substrate 10 is a base material on which the stopper part 70, the detection electrode parts 21, etc. are provided. In the substrate 10, a first recess part 12 is provided in one surface on which the stopper part 70, the detection electrode parts 21, etc. are provided. In the plan view from the Z-axis direction as the perpendicular direction with respect to the substrate 10, in the first recess part 12, the detection electrode parts 21 and the movable member 50 are provided inside and a first bottom surface 12a placed to overlap the first recess part 12 is provided.

An insulating material may be used as the material of the substrate 10. In the physical quantity sensor 1 of the embodiment, a base material containing borosilicate glass is used for the substrate 10.

In the following explanation, one surface of the substrate 10 on which the first recess part 12 is provided and the lid member 60, which will be described later, is connected is referred to as a principal surface 10a.

### Detection Electrode Parts 21

The detection electrode parts 21 as fixed electrode parts are provided on the first bottom surface 12a with gaps 13 with respect to the movable member 50 so that at least part of the detection electrode parts 21 may overlap with the movable member 50 in the plan view from the Z-axis direction as a perpendicular direction with respect to the above described first bottom surface 12a. The detection electrode parts 21 include a first detection electrode part 21a and a second detection electrode part 21b. Note that the first detection electrode part 21a and the second detection electrode part 21b are electrically insulated from each other.

The detection electrode parts 21 are provided on both sides of the first bottom surface 12a with a support axis Q around which the movable member 50 tilts at the center in a plan view from the Z-axis direction as a perpendicular direction with respect to the movable member 50.

On the first bottom surface 12a, the first detection electrode part 21a is provided on one of the sides with the support axis Q at the center and the second detection electrode part 21b is provided on the other of the sides with the support axis Q at the center.

Note that the support axis Q is a virtual line extending in a direction in which the support parts 42 supporting the movable member 50 extend, which will be described later.

As the detection electrode part 21, the first detection electrode part 21a is provided in the −X-axis direction shown in FIG. 1 with the support axis Q at the center so that a first movable member 50a (movable member 50) to be described later may overlap with part thereof. Further, as the detection electrode part 21, the second detection electrode part 21b is provided in the +X-axis direction shown in FIG. 1 with the support axis Q at the center so that a second movable member 50b (movable member 50) to be described later may overlap with part thereof.

Note that it is preferable that the first detection electrode part 21a and the second detection electrode part 21b have surface areas equal to each other. Further, it is preferable that the area in which the first movable member 50a (movable member 50) and the first detection electrode part 21a overlap and the area in which the second movable member 50b (movable member 50) and the second detection electrode part 21b overlap are equal to each other. This is because the magnitude and direction of the physical quantity of acceleration or the like applied to the physical quantity sensor 1 are detected by a difference in capacitances caused between the first movable member 50a and the second movable member 50b and between the first detection electrode part 21a and the second detection electrode part 21b.

A conducting material may be used as the material of the detection electrode parts 21. In the physical quantity sensor 1 of the embodiment, a conducting material including, for example, gold (Au), copper (Cu), aluminum (Al), indium (I), titanium (Ti), platinum (Pt), tungsten (W), tin (Sn) and silicon (Si) may be used for the detection electrode parts 21.

### Frame Part 40, Support Parts 42, Movable Member 50

The movable member 50 is provided on the first bottom surface 12a with the gaps 13 with respect to the detection electrode parts 21. The movable member 50 is supported by the frame part 40 via the support parts 42. The frame part 40 is provided along the outer edge of the first recess part 12 on the principal surface 10a of the substrate 10.

### Movable Member 50

The movable member 50 includes the first movable member 50a and the second movable member 50b with the support axis Q at the center. The movable member 50 is supported on the frame part 40 provided on the principal surface 10a via the support parts 42, and thereby, may be provided with the gaps 13 between the detection electrode parts 21 and itself. The movable member 50 is provided apart with the gaps 13 between the detection electrode parts 21 and itself, and thereby, may tilt (seesaw) toward the first bottom surface 12a on which the detection electrode parts 21 are provided around the support parts 42 as the support axis Q. Note that the surface of the movable member 50 opposed to the detection electrode parts 21 is referred to as a principal surface in the movable member 50.

Further, the movable member 50 seesaws around the support parts 42 as the support axis Q, and thereby, the gaps 13 (distances) between the detection electrode parts 21 and itself change. In response to the change of the gaps 13 between the movable member 50 and the detection electrode parts 21, capacitances caused between the movable member 50 and the detection electrode parts 21 may be changed.

When acceleration in the vertical direction (e.g., acceleration of gravity) is applied to the movable member 50, moment of rotation (moment of force) is generated in the respective first movable member 50a and second movable member 50b. Here, when the moment of rotation of the first movable member 50a (e.g., counter-clockwise moment of rotation) and the moment of rotation of the second movable member 50b (e.g., clockwise moment of rotation) are balanced, the tilt of the movable member 50 does not change and the detection of acceleration is impossible. Therefore, the movable member 50 is provided so that the moment of rotation of the first movable member 50a and the moment of rotation of the second movable member 50b may not be balanced and a predetermined tilt may be generated in the movable member 50 when acceleration in the vertical direction is applied.

In the physical quantity sensor 1, the support axis Q is provided in a location out of the center (center of gravity) of the movable member 50 (the distances from the support axis Q to the ends of the first movable member 50a and the second movable member 50b are different), and thereby, the first movable member 50a and the second movable member 50b have different masses from each other. That is, the movable member 50 has different masses between one side (first movable member 50a) and the other side (second movable member 50b) with the support axis Q at the boundary. In the illustrated example, the distance from the support axis Q to the end surface of the first movable member 50a is smaller than the distance from the support axis Q to the end surface of the second movable member 50b. Further, the thickness of the first movable member 50a and the thickness of the second movable member 50b are nearly equal. Therefore, the mass of the first movable member 50a is smaller than the mass of the second movable member 50b. As described above, the first movable member 50a and the second movable member 50b have the different masses from each other, and thereby, when acceleration in the vertical direction is applied, the moment of rotation of the first movable member 50a and the moment of rotation of the second movable member 50b may be unbalanced. Therefore, when acceleration in the vertical direction is applied, the predetermined tilt may be generated in the movable member 50.

The movable member 50 has capacitances (variable capacitances) generated between the detection electrode parts and itself. Specifically, a capacitance (variable capacitance) C1 is formed between the movable member 50 (first movable member 50a) and the first detection electrode part 21a. Further, a capacitance (variable capacitance) C2 is formed between the movable member 50 (second movable member 50b) and the second detection electrode part 21b.

The capacitances C1, C2 change in response to the gaps 13 (distances) between the detection electrode parts 21 and the movable member 50.

For example, the capacitances C1, C2 have nearly equal capacitance values to each other when the movable member 50 is horizontal with respect to the substrate 10. The gap (distance) between the movable member 50 and the first detection electrode part 21a and the gap 13 (distance) between the movable member 50 and the second detection electrode part 21b are equal, and the capacitance values of the capacitances C1, C2 are also equal.

Further, for example, when the movable member 50 tilts around the support axis Q as a fulcrum, the capacitance values of the capacitances C1, C2 change in response to the tilt of the movable member 50. The gap 13 (distance) between the movable member 50 and the first detection electrode part 21a and the gap 13 (distance) between the movable member 50 and the second detection electrode part 21b differ in response to the tilt of the movable member 50, and the capacitance values of the capacitances C1, C2 also differ in response to the gaps 13 (distances).

### Support Parts 42

The support parts 42 are extended from the movable member 50 toward the frame part 40. The support parts 42 are provided as the support axis Q around which the movable member 50 tilts.

The support parts 42 may function as a torsion spring. The support parts 42 may twist in the direction along the rotation axis of the support axis Q. The support parts 42 function as the torsion spring, and thereby, the movable member 50 may tilt (seesaw) in response to the physical quantity of acceleration or the like. The support parts 42 have toughness for “torsional deformation” generated by the tilt of the movable member 50, and may suppress breakage of the support parts 42.

### Frame Part 40

The frame part 40 is provided on the principal surface 10a of the substrate 10 along the outer edge of the first recess part 12 in the plan view from the Z-axis direction as the perpendicular direction with respect to the substrate 10. The frame part 40 is provided on the principal surface 10a with gaps 43 between the movable member 50 and itself.

On the frame part 40, the movable member 50 is supported by the support parts 42 as shown in FIG. 1.

The movable member 50 has the gaps 43 between the frame part 40 and the movable member 50 and the gaps 13 between the detection electrode parts 21 and the movable member 50, and thereby, may seesaw around the support part 42 as the support axis Q.

In the physical quantity sensor 1 of the embodiment, the frame part 40, the support parts 42, and the movable member 50 may be integrally provided by patterning of one base material.

A conducting material is preferably used as the material for the movable member 50. This is for the movable member 50 to function as an electrode. Note that, when the movable member 50 is formed integrally with the frame part 40 and the support parts 42, it is preferable to use a material containing silicon that is easily processed by photolithography, for example.

The material for the frame part 40 is not particularly limited, but various kinds of materials may be used. Note that, when the frame part 40 is formed integrally with the movable member 50 and the support parts 42, it is preferable to use a material containing silicon that is easily processed by photolithography, for example.

The material for the support parts 42 is not particularly limited as long as it has toughness, but various kinds of materials may be used. Note that, when the support parts 42 is formed integrally with the movable member 50 and the frame part 40, it is preferable to use a material containing silicon that is easily processed by photolithography, for example.

Namely, insulating materials may be used for the frame part 40, the support parts 42, and the movable member 50. When the movable member 50 is formed using an insulating material, an electrode film may be provided on the surface of the movable member 50 opposed to the detection electrode parts 21. Thereby, capacitances may be generated between the detection electrode parts 21 and the movable member 50, and changes in capacitances in response to the changes of the gaps 13 between the detection electrode parts 21 and the movable member 50 due to the tilt of the movable member 50 by the physical quantity of acceleration or the like may be obtained.

### Stopper Part 70

The stopper part 70 is, as shown in FIGS. 1 and 3, placed in the gap 43 between the movable member 50 and the frame part 40 in the plan view from the Z-axis direction as the perpendicular direction with respect to the substrate 10 and provided to stand from the first bottom surface 12a of the first recess part 12 along the movable member 50.

The stopper part 70 is provided for regulation of the displacement of the movable member 50.

More specifically, the stopper part 70 is provided, without hindering the tilt of the movable member 50 in the Z-axis direction as a first direction by the physical quantity of acceleration or the like applied to the physical quantity sensor 1, for regulation of the displacement of the movable member 50 in a second direction (Y-axis direction) crossing the first direction. Further, the stopper part 70 is provided for regulation of in-plane rotation displacement of the principal surface of the movable member 50 around the Z-axis along the first direction as a rotation axis.

In the physical quantity sensor 1 of the embodiment, when excessive displacement is generated in the −Y-axis direction, the movable member 50 comes into contact with the stopper part 70 and the displacement is regulated. Further, when the in-plane rotation displacement of the principal surface of the movable member 50 around the Z-axis as the rotation axis is generated, the movable member 50 comes into contact with the stopper part 70 and the displacement is regulated. Note that the placement of the stopper part 70 is not particularly limited, but the stopper part may be provided along the outer edge of the movable member 50 in a direction in which the regulation of the displacement of the movable member 50 is desired.

Though not illustrated, for example, when the displacement of the movable member 50 in the +Y-axis direction is regulated, the stopper part 70 may be provided along the outer edge of the movable member 50 crossing the support part 42 at the +Y-axis direction side. Or, a plurality of the stopper parts 70 may be provided.

The stopper part 70 in the physical quantity sensor 1 includes a base part 72 and a top part 74. In the stopper part 70, the base part 72 is provided to stand from the first bottom surface 12a to the principal surface 10a and the top part 74 is provided to be superposed on the base part 72.

For example, a material containing borosilicate glass may be used for the base part 72 like the substrate 10. The base part 72 may be integrally provided with the first recess part 12 using the same material as that of the substrate 10.

For example, a base material containing silicon may be used for the top part 74 like the movable member 50, the support parts 42, and the frame part 40. The top part 74 may be integrally provided with the movable member 50, the support parts 42, and the frame part 40 using the same material as that of the movable member 50 etc.

In addition, it is preferable that the stopper part 70 is at the same potential as the movable member 50.

The stopper part 70 is at the same potential as the movable member 50, and thereby, even in contact with the movable member 50, clinging may be suppressed because no electrostatic force acts thereon.

Accordingly, the top part 74 is integrally provided with the movable member 50 etc. at the same potential as the movable member 50. Further, the base part 72 has a conducting film (not shown) formed on an end surface 72s in contact with the movable member 50 and is set at the same potential with the movable member 50 because the top part 74 and the conducting film are electrically connected.

Lid member 60

The lid member 60 is provided in connection to the substrate 10. A second recess part 62 is provided in the lid member 60. The lid member 60 is connected to the principal surface 10a of the substrate 10 on the top surface of the second recess part 62 as a joining surface 62a. In the lid member 60, a cavity 65 as a space surrounded by the first recess part 12 provided in the substrate 10 by the connection to the substrate 10 and the second recess part 62 provided in the lid member 60 is formed. The movable member 50 etc. are housed in the cavity 65 formed by the substrate 10 and the lid member 60, and thereby, the movable member 50 etc. may be protected from disturbances to the physical quantity sensor 1.

It is preferable that the second recess part 62 is provided in a depth at which the movable member 50 and the lid member 60 are not in contact when the movable member 50 tilts in the first direction in which the substrate 10 and the lid member 60 are connected. Further, it is preferable that the second recess part 62 is provided in a deeper part compared to the thickness of the movable member 50 at least in the first direction in which the movable member 50 tilts.

Note that the lid member 60 is grounded by wiring (not shown).

A conducting material is preferably used for the lid member 60. For example, a base material containing silicon that is easily processed is used for the lid member 60 of the embodiment. The base material containing silicon is used for the lid member 60, and thereby, the lid member may be connected (joined) by anodic bonding to the substrate 10 using borosilicate glass.

### Wiring Part

In the physical quantity sensor 1, the wiring part (not shown) for extraction of the capacitances (C1, C2) generated between the above described detection electrode parts 21 and the movable member 50 as electric signals is provided. By the wiring part, the capacitances generated in response to the tilt of the movable member 50 may be output to the outside of the physical quantity sensor 1.

### Action of Physical Quantity Sensor 1

An action of the physical quantity sensor 1 of the embodiment will be explained.

FIGS. 4A to 4C are schematic diagrams for explanation of the action of the physical quantity sensor 1, in which illustration of the other configuration than the detection electrode parts 21 and the movable member 50 is omitted.

When acceleration (e.g., gravitational acceleration) in the first direction (Z-axis direction) is applied to the physical quantity sensor 1, moment of rotation around the support axis Q is generated in the movable member 50.

FIG. 4A exemplifies a state in which acceleration G11 from the −Z-axis direction to the +Z-axis direction is applied to the movable member 50 with respect to the physical quantity sensor 1.

In the state, more acceleration acts on the movable member 50 at the second movable member 50b side than at the first movable member 50a side. Therefore, a clockwise force around the support axis Q as the rotation axis acts on the movable member 50. Therefore, the movable member 50 (second movable member 50b) tilts toward the second detection electrode part 21b side around the support axis Q as the rotation axis.

Thereby, the gap 13 between the movable member 50 (second movable member 50b) and the second detection electrode part 21b becomes smaller (shorter), and the capacitance value of the capacitance C2 between the movable member 50 and the second detection electrode part 21b increases. On the other hand, the gap 13 between the movable member 50 (first movable member 50a) and the first detection electrode part 21a becomes larger (longer), and the capacitance value of the capacitance C1 between the movable member 50 and the first detection electrode part 21a decreases.

FIG. 4B exemplifies a state in which no acceleration is applied to the physical quantity sensor 1. In the state, the acceleration G11 is not applied to the first movable member 50a side or the second movable member 50b, and no force acts on the movable member 50. Accordingly, the movable member 50 does not tilt in either direction. That is, the movable member 50 is nearly horizontal with respect to the substrate 10.

Thereby, the gap 13 between the movable member 50 (first movable member 50a) and the first detection electrode part 21a and the gap 13 between the movable member 50 (second movable member 50b) and the second detection electrode part 21b become nearly equal. Therefore, the capacitance values of the capacitance C1 between the movable member 50 and the first detection electrode part 21a and the capacitance C2 between the movable member 50 and the second detection electrode part 21b become nearly equal.

Further, compared to the state of the physical quantity sensor 1 shown in FIG. 4A, the gap 13 between the movable member 50 (first movable member 50a) and the first detection electrode part 21a is smaller and the capacitance C1 between the parts increases. Furthermore, the gap 13 between the movable member 50 (second movable member 50b) and the second detection electrode part 21b increases and the capacitance C2 between the parts decreases.

FIG. 4C exemplifies a state in which acceleration G21 from the +Z-axis direction to the −Z-axis direction is applied to the movable member 50 with respect to the physical quantity sensor 1.

In the state, the acceleration G21 is applied to the first movable member 50a side, and a counter-clockwise force around the support axis Q as the rotation axis acts on the movable member 50. Therefore, the movable member 50 tilts toward the first detection electrode part 21a side. FIG. 4C shows the state in which the acceleration G21 is larger than the gravitational acceleration acting on the second movable member 50b. Accordingly, the movable member 50 tilts toward the second movable member 50b side.

Thereby, the gap 13 between the movable member 50 (first movable member 50a) and the first detection electrode part 21a becomes smaller (shorter), and the capacitance value of the capacitance C1 between the movable member 50 and the first detection electrode part 21a increases. On the other hand, the gap 13 between the movable member 50 (second movable member 50b) and the second detection electrode part 21b becomes larger (longer), and the capacitance value of the capacitance C2 between the movable member 50 and the second detection electrode part 21b decreases.

Further, compared to the state in which no acceleration is applied to the physical quantity sensor 1 shown in FIG. 4B, the gap 13 between the movable member 50 (first movable member 50a) and the first detection electrode part 21a is smaller and the capacitance C1 between the parts increases. Furthermore, the gap 13 between the movable member 50 (second movable member 50b) and the second detection electrode part 21b increases and the capacitance value of the capacitance C2 between the parts decreases.

The physical quantity sensor 1 of the embodiment may detect the values of the acceleration (e.g., G11, G21) from the changes of the two capacitance values. For example, the changes of the capacitance values in the state of FIG. 4A are determined with reference to the capacitance values obtained in the state of FIG. 4B, and thereby, the direction in which the acceleration G11 acts and the force may be detected. Further, the changes of the capacitance values in the state of FIG. 4C are determined, and thereby, the direction in which the acceleration G21 acts and the force may be detected.

According to the above described first embodiment, the following advantages may be obtained.

According to the physical quantity sensor, the displacement of the movable member 50 in the Y-axis direction and the in-plane rotation displacement of the principal surface of the movable member 50 may be regulated. Therefore, breakage of the movable member 50 and breakage of the support parts 42 supporting the movable member 50 due to excessive displacement of the movable member 50 may be suppressed. Further, fluctuations in opposed area of the movable member and the detection electrode parts 21 with the above described displacement of the movable member 50 decrease and variations in characteristics of the capacitances that change in response to the acceleration or the like may be suppressed. Thus, the physical quantity sensor 1 in which the breakage of the support parts 42 or the like caused by excessive displacement of the movable member 50 is suppressed and variations in characteristics of the capacitances C1, C2 between the movable member 50 and the detection electrode parts 21 that change in response to the acceleration or the like is suppressed may be obtained.

### Second Embodiment

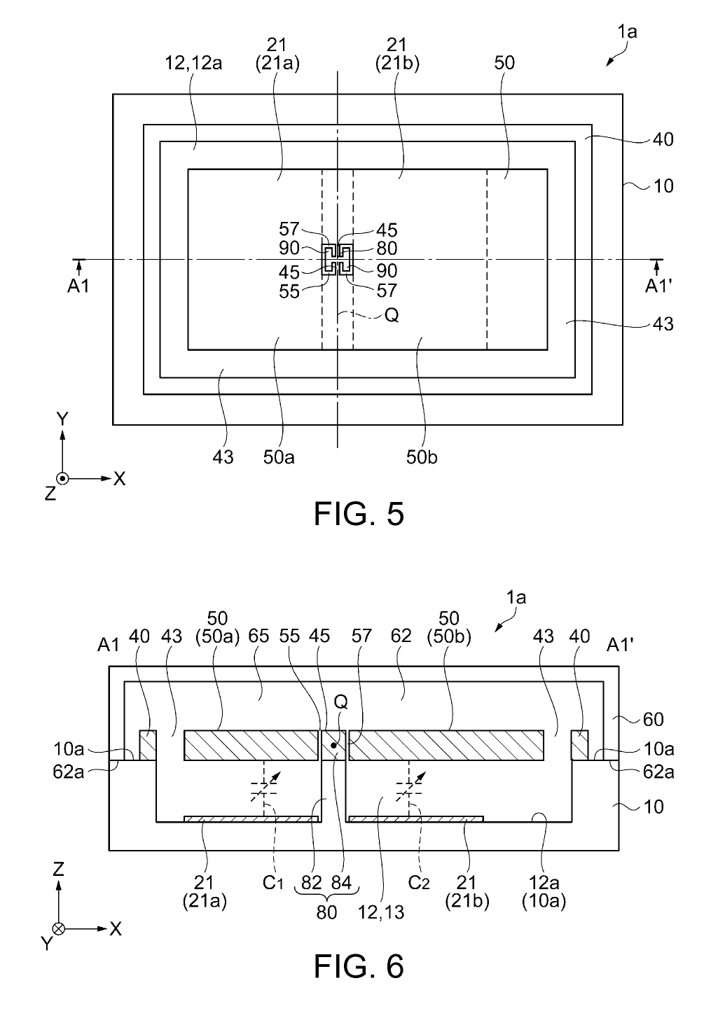

A physical quantity sensor according to the second embodiment will be explained using FIGS. 5 and 6.

FIG. 5 is a plan view schematically showing the physical quantity sensor according to the second embodiment. FIG. 6 schematically shows a section of the physical quantity sensor in a part shown by line segment A1-A1′ in FIG. 5.

In FIGS. 5 and 6, an X-axis, a Y-axis, and a Z-axis are shown as three axes orthogonal to one another. The Z-axis is an axis indicating a thickness direction in which a substrate and a lid member overlap.

The physical quantity sensor 1a according to the second embodiment is different from the physical quantity sensor 1 explained in the first embodiment in a configuration that supports the movable member 50 with respect to the substrate 10 and a configuration of stopper parts 90. The other configurations etc. are nearly the same as those of the physical quantity sensor 1, and the same configurations have the same signs and numerals and their explanation will be partially omitted.

### Structure of Physical Quantity Sensor 1a

The physical quantity sensor 1a shown in FIGS. 5 and 6 may be used as a sensor for measurement of a physical quantity of acceleration in the vertical direction (Z-axis direction) or the like as is the case of the above described physical quantity sensor 1 in the first embodiment.

In the physical quantity sensor 1a, as shown in FIGS. 5 and 6, a substrate 10, detection electrode parts 21 as fixed electrode parts on the substrate 10, a fixing part 80 on the substrate 10, and a movable member 50 supported on the fixing part 80 via support parts 45 are provided. Further, the stopper parts 90 are provided in connection to the fixing part 80.

### Movable Member 50

In the movable member 50, a hollow part 55 is provided on an extension of the support axis Q when the movable member tilts in response to the physical quantity of acceleration or the like and on a virtual line (line segment A1-A1′ shown in FIG. 5) extending in the second direction crossing the support axis Q.

In the hollow part 55, the fixing part 80 and the support parts 45 extended from the fixing part 80 toward the movable member 50 are provided to be inside in a plan view of the movable member 50 from a perpendicular direction with respect to the substrate 10.

### Fixing Part 80

The fixing part 80 includes a base part 82 and a top part 84 as shown in FIGS. 5 and 6.

In the fixing part 80, the base part 82 is provided to stand from the first bottom surface 12a to the principal surface 10a and the top part 84 is provided to be superposed on the base part 82.

For example, a material containing borosilicate glass may be used for the base part 82 like the substrate 10. The base part 82 may be integrally provided with the first recess part 12 using the same material as that of the substrate 10.

For example, a base material containing silicon may be used for the top part 84 like the movable member 50, the support parts 45, and the frame part 40. The top part 84 may be integrally provided with the movable member 50, the support parts 45, and the frame part 40 using the same material as that of the movable member 50 etc.

### Support Parts 45

The support parts 45 are extended from the fixing part 80 along the support axis Q toward the movable member 50. Specifically, the support parts 45 are extended from the top part 84 of the fixing part 80 in the +Y-axis direction and the −Y-axis direction toward the movable member 50. Thereby, the movable member 50 is suspended on the fixing part 80 by the support parts 45 and may tilt around the support parts 45 as the support axis Q.

The support part 45 is integrally provided with the movable member 50, the frame part 40, and the above described top part 84 of the fixing part 80 using the same material like the above described physical quantity sensor 1 in the first embodiment.

### Stopper Parts 90

The stopper parts 90 are extended from the fixing part 80 to be inside of the hollow part 55 provided in the movable member 50 as shown in FIGS. 5 and 6. The stopper parts 90 are provided in parallel to the support parts 45 along the inner edge of the movable member 50 facing the hollow part 55. The stopper parts 90 are extended from the fixing part 80 (top part 84) in the second direction crossing the first direction in which the support parts 45 extend, and further extended at the end extending in the second direction toward both sides of the crossing first direction (+Y-axis direction, −Y-axis direction). The stopper parts 90 are provided apart with gaps 57 between the movable member 50 and themselves.

Further, the stopper parts 90 are provided in line symmetry with respect to the support parts 45 at the sides in the +X-direction and the −X-direction shown in FIG. 5.

The stopper parts 90 are provided for regulation of the in-plane rotation displacement in the principal surface of the movable member 50. More specifically, the stopper parts 90 are provided, without hindering the tilt of the movable member 50 in the Z-axis direction as the first direction by the physical quantity of acceleration or the like applied to the physical quantity sensor 1a, for regulation of the displacement of the movable member 50 in the second direction (Y-axis direction) and a third direction (X-axis direction) crossing the first direction.

In the physical quantity sensor 1a of the embodiment, when excessive displacement is generated in the movable member 50 in the X-axis direction or the Y-axis direction or in both the X-axis direction and the Y-axis direction, the movable member 50 comes into contact with the stopper parts 90, and thereby, the displacement is regulated.

In addition, it is preferable that the stopper parts 90 are at the same potential as the movable member 50.

The stopper parts 90 are at the same potential as the movable member 50, and thereby, even when the stopper parts 90 are in contact with the movable member 50, fluctuations of capacitances and ground faults caused between the movable member 50 and the detection electrode parts 21 may be suppressed.

Accordingly, the stopper parts 90 are integrally provided to be extended from the top part 84 of the fixing part 80. Thereby, the stopper parts 90 are electrically connected to the movable member 50 via the support parts 45 extended from the top part 84 toward the movable member 50 at the same potential as the movable member 50.

The other configurations are the same as those of the physical quantity sensor 1 and their explanation will be omitted.

According to the above described second embodiment, the following advantages may be obtained.

According to the physical quantity sensor 1a, the inner edge of the movable member 50 in which the hollow part 55 is provided is in contact with the fixing part 80 provided in the hollow part 55, and thereby, the in-plane rotation displacement of the principal surface of the movable member 50 around the rotation axis along the first direction may be regulated. Therefore, breakage of the movable member 50 and breakage of the support parts 45 supporting the movable member 50 due to excessive displacement of the movable member 50 may be suppressed. Further, the displacement in the in-plane rotation direction of the principal surface of the movable member 50 is regulated, and thereby, the opposed area of the movable member 50 and the detection electrode parts 21 decreases and variations in characteristics of the capacitances C1, C2 that change in response to the acceleration or the like may be suppressed.

Thus, the physical quantity sensor 1a in which the breakage of the support parts 45 or the like caused by excessive displacement of the movable member 50 is suppressed and variations in characteristics of the capacitances C1, C2 between the movable member 50 and the detection electrode parts 21 that change in response to the acceleration or the like are suppressed may be obtained. Further, the fixing part 80 is provided at one point, and thereby, the influence on the movable member 50 by the stress at fixation may be reduced.

Note that the invention is not limited to the above described first embodiment and second embodiment, but various changes and improvements may be made to the above described embodiments. Modified examples will be described as below.

### MODIFIED EXAMPLES

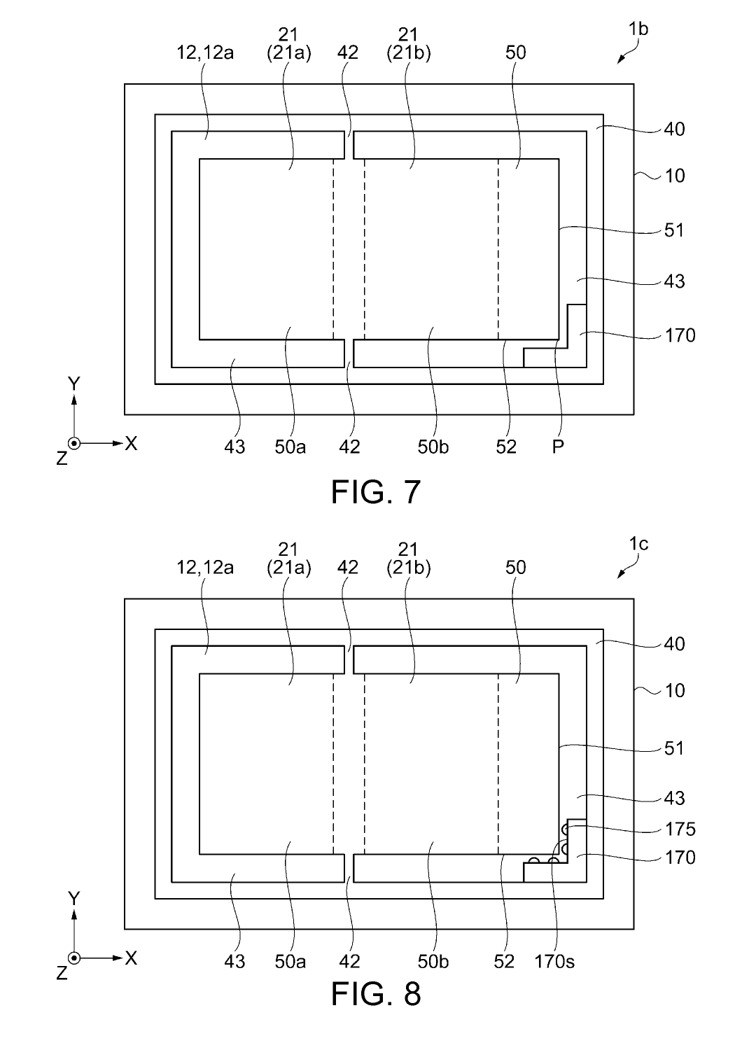

FIGS. 7 to 9 are plan views and a partially enlarged view schematically showing physical quantity sensors according to the modified examples.

The physical quantity sensors according to the modified examples are different in shapes and placements of stopper parts. The differences will be explained as below and the explanation of the same configurations will be partially omitted.

### Modified Example 1

FIG. 7 is the plan view schematically showing a physical quantity sensor according to the modified example 1.

The physical quantity sensor 1b according to the modified example 1 is different from the above described physical quantity sensor 1 in the first embodiment in shape and placement of a stopper part 170.

As shown in FIG. 7, in the physical quantity sensor 1b according to the modified example 1, the stopper part 170 is provided along a first side 51 as an outer edge of the movable member 50 in parallel to the support axis Q and a second side 52 intersecting with the first side 51 at an apex portion P. The stopper part 170 is provided in the gap 43 to bend along the first side 51 and the second side 52.

In the physical quantity sensor 1b, the stopper part 170 is provided along the first side 51 and the second side 52 of the movable member 50, and thereby, displacement in the −Y-axis direction as the second direction in which the support axis Q extends and displacement in the +X-axis direction as the third direction crossing the second direction may be regulated. Note that, in the physical quantity sensor 1b, the number of the stopper part 170 is not particularly limited and may be provided in the gap 43 on the diagonal line with respect to the apex portion P. Further, the stopper part 170 may be provided with respect to each of the apex portions P at which the outer edges of the movable member 50 intersect. Furthermore, the stopper part 170 may have an end surface opposed to the movable member 50 along the outer edge of the movable member 50 as a curved surface.

### Modified Example 2

FIG. 8 is the plan view schematically showing a physical quantity sensor according to the modified example 2.

The physical quantity sensor 1c according to modified example 2 is different from the above described physical quantity sensor 1b in the modified example 1 in that projecting portions 175 are provided on the stopper part 170.

As shown in FIG. 8, in the physical quantity sensor 1c according to the modified example 2, the stopper part 170 is provided along the first side 51 of the movable member 50 and the second side 52, and the projecting portions 175 are provided on the end surfaces 170s of the stopper part 170 opposed to the first side 51 and the second side 52 of the movable member 50.

In the physical quantity sensor 1c, the projecting portions 175 are provided on the end surfaces 170s of the stopper part 170, and thereby, the movable member 50 is in contact with the projecting portions 175 in point contact and displacement of the movable member 50 may be regulated. Therefore, the impact due to contact between the movable member 50 and the projecting portions 175 may be relaxed and breakage of the movable member 50 or the like may be suppressed. Note that the shape of the projecting portions 175 is not particularly limited, not the spherical shape, but a polygonal shape may be employed.

### Modified Example 3

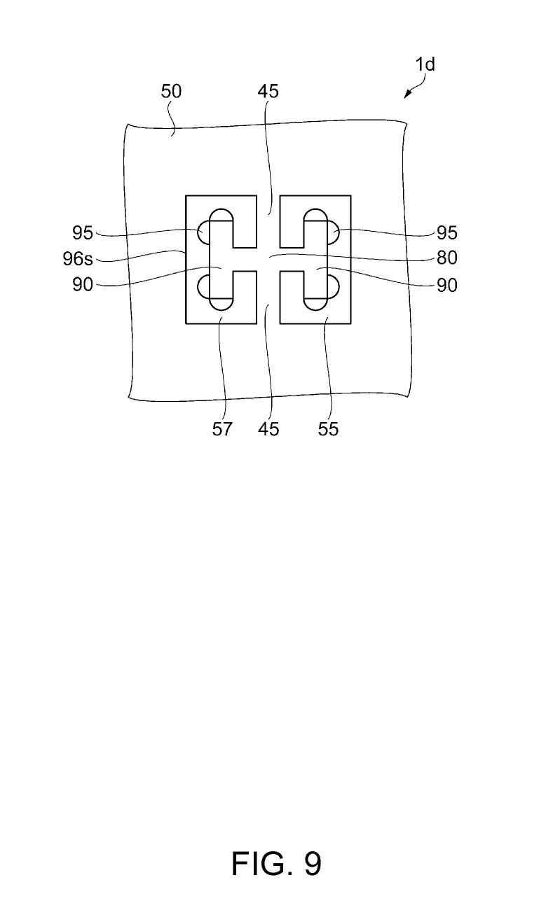

FIG. 9 is the plan view schematically showing a physical quantity sensor according to the modified example 3.

The physical quantity sensor 1d according to the modified example 3 is different from the above described physical quantity sensor 1a in the second embodiment in that projecting portions 95 are provided on the stopper parts 90.

As shown in FIG. 9, in the physical quantity sensor 1d according to the modified example 3, the projecting portions 95 are provided on the end surfaces 90s of the stopper parts 90 opposed to the movable member 50 (the inner edge of the movable member 50 facing the hollow part 55).

In the physical quantity sensor 1d, the projecting portions 95 are provided on the end surfaces 90s of the stopper parts 90, and thereby, the movable member 50 is in contact with the projecting portions 95 in point contact and displacement of the movable member 50 may be regulated. Therefore, the impact due to contact between the movable member 50 and the projecting portions 95 may be relaxed and breakage of the movable member 50, the fixing part 80, or the like may be suppressed. Note that the shape of the projecting portions 95 is not particularly limited, not the spherical shape, but a polygonal shape may be employed.

### Working Examples

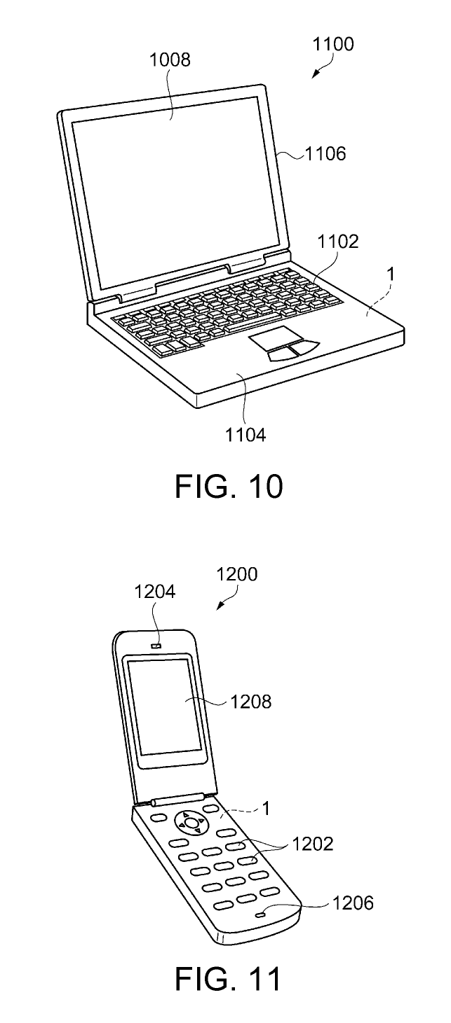

Working examples to which one of the physical quantity sensor 1 and the physical quantity sensors 1a to 1d according to one embodiment of the invention (hereinafter, collectively explained as the physical quantity sensor 1) is applied will be explained with reference to FIGS. 10 to 13.

### Electronic Apparatuses

Electronic apparatuses to which the physical quantity sensor 1 according to one embodiment of the invention is applied will be explained with reference to FIGS. 10 to 12.

FIG. 10 is a perspective view showing an outline of a configuration of a laptop (or mobile) personal computer as an electronic apparatus including the physical quantity sensor according to one embodiment of the invention. In the drawing, a laptop personal computer 1100 includes a main body unit 1104 having a keyboard 1102 and a display unit 1106 having a display part 1008, and the display unit 1106 is rotatably supported via a hinge structure part with respect to the main body unit 1104. The lap top personal computer 1100 contains the capacitance physical quantity sensor 1 that functions as an acceleration sensor or the like for sensing acceleration or the like applied to the laptop personal computer 1100 and displaying the acceleration or the like on the display unit 1106. In the physical quantity sensor 1, displacement of the movable member 50 in the second direction crossing the first direction in which the gaps 13 between the movable member 50 and the detection electrode parts 21 change and displacement in the in-plane rotation direction of the principal surface of the movable member 50 around the rotation axis along the first direction are regulated. Therefore, even when excessive acceleration or the like due to drop of the laptop personal computer 1100 or the like is applied, the acceleration or the like may be continuously detected. Thus, the reliable laptop personal computer 1100 with the above described physical quantity sensor 1 may be obtained.

FIG. 11 is a perspective view showing an outline of a configuration of a cell phone (including a PHS) as the electronic apparatus including the physical quantity sensor according to one embodiment of the invention. In the drawing, a cell phone 1200 includes a plurality of operation buttons 1202, an ear piece 1204, and a mouthpiece 1206, and a display part 1208 is provided between the operation buttons 1202 and the ear piece 1204. The cell phone 1200 contains the capacitance physical quantity sensor 1 that functions as an acceleration sensor or the like for sensing acceleration or the like applied to the cell phone 1200 and assisting the operation of the cell phone 1200. In the physical quantity sensor 1, displacement of the movable member 50 in the second direction crossing the first direction in which the gaps 13 between the movable member 50 and the detection electrode parts 21 change and displacement in the in-plane rotation direction of the principal surface of the movable member 50 around the rotation axis along the first direction are regulated. Therefore, even when excessive acceleration or the like due to drop of the cell phone 1200 or the like is applied, the acceleration or the like may be continuously detected. Thus, the reliable cell phone 1200 with the above described physical quantity sensor 1 may be obtained.

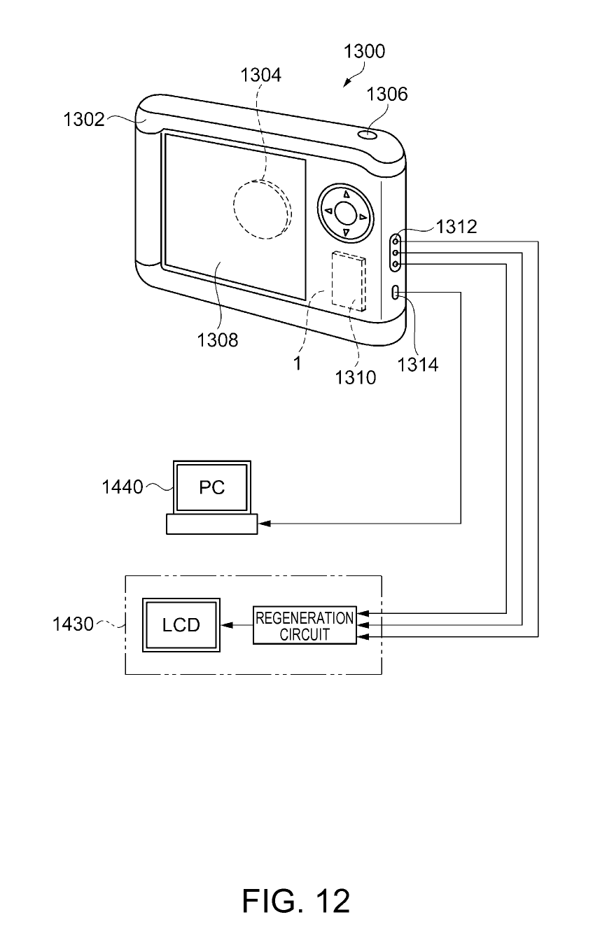

FIG. 12 is a perspective view showing an outline of a configuration of a digital still camera as the electronic apparatus including the physical quantity sensor according to one embodiment of the invention. Note that, in the drawing, connection to an external device is simply shown. Here, in a camera of related art, a silver halide photographic film is exposed to light by an optical image of a subject and, on the other hand, a digital still camera 1300 photoelectrically converts an optical image of a subject using an image sensing device such as a CCD (Charge Coupled Device) and generates imaging signals (image signals).

On a back surface of a case (body) 1302 in the digital still camera 1300, a display part 1308 is provided and adapted to display based on the imaging signals by the CCD, and the display part 1308 functions as a finder that displays the subject as an electronic image. Further, on the front side (the rear side in the drawing) of the case 1302, a light receiving unit 1304 including an optical lens (imaging system), the CCD, etc. is provided.

When a photographer checks the subject image displayed on the display part 1308 and presses down a shutter button 1306, the imaging signals of the CCD at the time are transferred and stored into a memory 1310. Further, in the digital still camera 1300, a video signal output terminal 1312 and an input/output terminal for data communication 1314 are provided on the side surface of the case 1302. Furthermore, as illustrated, a liquid crystal display 1430 is connected to the video signal output terminal 1312 and a personal computer 1440 is connected to the input/output terminal for data communication 1314, respectively, as appropriate. In addition, by predetermined operation, the imaging signals stored in the memory 1310 are output to the liquid crystal display 1430 and the personal computer 1440. The digital still camera 1300 contains the capacitance physical quantity sensor that functions as an acceleration sensor that senses acceleration due to drop for operating the function of protecting the digital still camera 1300 from the drop. In the physical quantity sensor 1, displacement of the movable member 50 in the second direction crossing the first direction in which the gaps 13 between the movable member 50 and the detection electrode parts 21 change and displacement in the in-plane rotation direction of the principal surface of the movable member 50 around the rotation axis along the first direction are regulated. Therefore, even when excessive acceleration or the like due to drop of the digital still camera 1300 or the like is applied, the acceleration or the like may be continuously detected. Thus, the reliable digital still camera 1300 with the above described physical quantity sensor 1 may be obtained.

Note that the physical quantity sensor 1 according to one embodiment of the invention may be applied not only to the laptop personal computer (mobile personal computer) in FIG. 10, the cell phone in FIG. 11, and the digital still camera in FIG. 12 but also to an electronic apparatus including an inkjet ejection device (for example, an inkjet printer), a television, a video camera, a video tape recorder, a car navigation system, a pager, a personal digital assistance (with or without communication function), an electronic dictionary, a calculator, an electronic game machine, a word processor, a work station, a videophone, a security television monitor, electronic binoculars, a POS terminal, a medical device (for example, an electronic thermometer, a sphygmomanometer, a blood glucose meter, an electrocardiographic measurement system, an ultrasonic diagnostic system, or an electronic endoscope), a fish finder, various measurement instruments, meters and gauges (for example, meters for vehicles, airplanes, and ships), a flight simulator, etc., for example.

### Moving Object

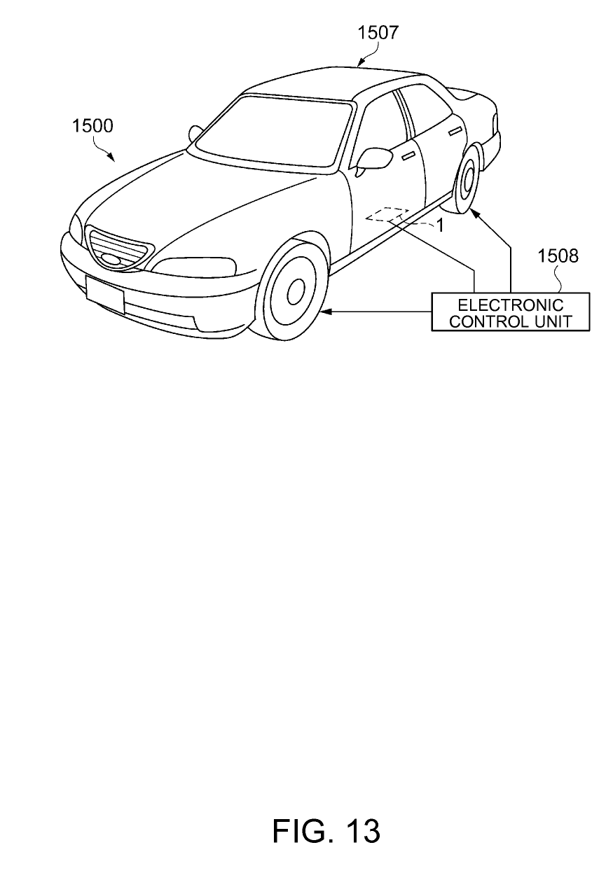

FIG. 13 is a perspective view schematically showing an automobile as an example of a moving object. In an automobile 1500, the physical quantity sensor 1 that functions as an acceleration sensor is mounted on various kinds of control units. For example, as shown in the drawing, in the automobile 1500 as the moving object, an electronic control unit (ECU) 1508 that contains the physical quantity sensor 1 that senses the acceleration of the automobile 1500 and controls output of the engine is mounted on a vehicle body 1507. The acceleration is sensed and the engine is controlled to appropriate output in response to the attitude of the vehicle body 1507, and thereby, the automobile 1500 as an efficient moving object with suppressed consumption of fuel or the like may be obtained.

In addition, the physical quantity sensor 1 may be widely applied to a vehicle body attitude control unit, an antilock brake system (ABS), an airbag, or a tire pressure monitoring system (TPMS).

In the physical quantity sensor 1, displacement of the movable member 50 in the second direction crossing the first direction in which the gaps 13 between the movable member 50 and the detection electrode parts 21 change and displacement in the in-plane rotation direction of the principal surface of the movable member 50 around the rotation axis along the first direction are regulated. Therefore, even when excessive acceleration or the like due to vibration of the automobile 1500 or the like is applied, the acceleration or the like may be continuously detected. Thus, the reliable automobile 1500 with the above described physical quantity sensor 1 may be obtained.

What is claimed is:

1. A physical quantity sensor comprising:
a fixed electrode part;
a movable member supported by a support part above the fixed electrode part to which a principal surface thereof is opposed; and
a stopper part provided to be opposed to at least a part of an outer edge of the movable member and regulating in-plane rotation displacement of the principal surface of the movable member.

2. The physical quantity sensor according to claim 1, wherein the stopper part is provided to be opposed to a corner portion of the movable member.

3. The physical quantity sensor according to claim 2, wherein the stopper part is provided to be opposed to each of a first side and a second side forming an angle with the first side, the sides forming the corner portion of the movable member.

4. The physical quantity sensor according to claim 2, wherein the stopper part is provided along the corner portion of the movable member.

5. The physical quantity sensor according to claim 3, wherein the stopper part is provided along the corner portion of the movable member.

6. The physical quantity sensor according to claim 1, wherein a hollow part is provided in the movable member,
a fixing part is provided in the hollow part in a plan view of the movable member, and
the movable member is suspended by the support part extended from the fixing part.

7. The physical quantity sensor according to claim 6, wherein a projection is provided on at least one of an edge of the hollow part of the movable member and the fixing part.

8. A physical quantity sensor comprising:
a fixed electrode part;
a movable member supported above the fixed electrode part to which a principal surface thereof is opposed and including a hollow part;
a fixing part provided in the hollow part in a plan view of the movable member;
a support part extended from the fixing part toward the movable member and suspending the movable member on the fixing part; and
a stopper part provided to be opposed to at least a part of an outer edge of the movable member and regulating in-plane rotation displacement of the principal surface of the movable member.

9. The physical quantity sensor according to claim 1, wherein the stopper part has a projection shape.

10. The physical quantity sensor according to claim 1, wherein the stopper part and the movable member are at the same potential.

11. An electronic apparatus comprising the physical quantity sensor according to claim 1.

12. A moving object comprising the physical quantity sensor according to claim 1.
